(19) United States
(12) Patent Application Publication
(10) Pub. No.: US 2026/0087030 A1
(43) Pub. Date: Mar. 26, 2026

(54) SYSTEMS AND METHODS FOR CONVERTING DOCUMENTS WITH MEDIA INTO AI-READY AND MACHINE-READABLE FORMATS

(71) Applicant: CABLE TELEVISION LABORATORIES, INC., Louisville, CO (US)

(72) Inventors: Megan H. Collins, Louisville, CO (US); Austin Pahl, Chapel Hill, NC (US); Paul Fonte, Arvada, CO (US); Léo Chely, Denver, CO (US); Tyler Glenn, Kalispell, MT (US); Marcos Gava, Bento Gonçalves (BR)

(21) Appl. No.: 19/408,221

(22) Filed: Dec. 3, 2025

Related U.S. Application Data
(63) Continuation-in-part of application No. 19/322,416, filed on Sep. 8, 2025.
Application No. 19/322,416 is a continuation-in-part of application No. 19/222,001, filed on May 29, 2025.
(60) Provisional application No. 63/653,106, filed on May 29, 2024.
(60) Provisional application No. 63/691,923, filed on Sep. 6, 2024.
(60) Provisional application No. 63/722,488, filed on Nov. 19, 2024.
(60) Provisional application No. 63/743,054, filed on Jan. 8, 2025.
(60) Provisional application No. 63/757,616, filed on Feb. 12, 2025.
(60) Provisional application No. 63/758,253, filed on Feb. 13, 2025.
(60) Provisional application No. 63/821,107, filed on Jun. 10, 2025.

(51) Int. Cl. G06F 16/25; G06F 16/334; G06V 30/40

(52) U.S. Cl. CPC G06F 16/258; G06F 16/3347; G06V 30/40

(57) ABSTRACT

Systems and methods for converting documents with media into AI-ready and machine-readable formats are provided. A document conversion service is configured to convert a document from an input format to a machine-readable format by performing the operations of: inputting a document page of the document into a converter configured to convert text in the document page from the input format to the machine-readable format to yield a converted text page and to extract media data from the document to yield extracted media data. The operations also include inputting the extracted media data into the automated alt text service to generate extracted alt text and generating a media reference that comprises a path to the extracted media data. The operations also include inputting the extracted alt text and the media reference into a location in the converted text page where the corresponding extracted media data was extracted.

### CROSS REFERENCE TO RELATED APPLICATIONS

This application is a continuation-in-part of co-pending U.S. application Ser. No. 19/322,416, filed on Sep. 8, 2025, which claims the benefit of and priority to U.S. Provisional Application No. 63/691,923, filed on Sep. 6, 2024 and 63/722,488, filed on Nov. 19, 2024, each of which applications are incorporated herein by reference in their entireties. U.S. application Ser. No. 19/322,416 is also a continuation-in-part of co-pending U.S. application Ser. No. 19/222,001, filed on May 29, 2025, which claims the benefit of and priority to U.S. Provisional Application No. 63/653,106, filed on May 29, 2024 and 63/757,616, filed on Feb. 2, 2025, each of which applications are incorporated herein by reference in their entireties. This application also claims the benefit of and priority to U.S. Provisional Application No. 63/743,054, filed on Jan. 8, 2025, 63/758,253, filed on Feb. 13, 2025, and 63/821,107, filed on Jun. 10, 2025, each of which applications are incorporated herein by reference in their entireties.

### BACKGROUND

The field of the disclosure relates generally to document conversion, and more particularly, to conversion of documents with media using a machine-learning based automated alternative text service.

Network as a Service (NaaS) is a common application programming interface (API) across operators targeting multi-access networks that enables network-aware application deployment and enhanced performance. NaaS enables developers, internal operations, and hyperscalers the ability to request network services, exchange data, and automate deployment of applications. By leveraging standard intent-based APIs that expose network services and data while reducing the complexity and domain knowledge of the underlying access technology, new relationships between network operators and third-party developers can be established more seamlessly.

However, end users and Multiple System Operators (MSOs) may become frustrated when, for example, an end user's internet does not work properly at the desired location. If the end user's internet appears to be running slowly or a video conference call or a tv show freezes and/or buffers, then the end user may get frustrated with the MSO. In such instances, determining the root cause of the issue can be difficult for both the end user and the MSO as there is currently no communication system between the end user's application and the network.

In a different application, generative AI (GAI) provides for the accumulation of knowledge from experts, encodes the knowledge for fast access, and can incorporate situational information to create an equivalence of an expert assistant. More specifically, language models and large language models (LLM) can provide information that is immediately useful to a user. Such GAI and LLMs can be used to, for example provide training for entry level or new employees to a company. However, language models and LLMs do not always provide accurate outputs or answers. In some embodiments, the language models or the LLM may use Retrieval Augmented Generation (“RAG”), which references an external knowledge base to improve the accuracy of the output from the LLM.

Though LLMs with RAG can improve the accuracy of the output, the LLM may still produce outputs with inaccuracies. Thus, it is desirable to evaluate and validate outputs from the LLM (with or without RAG). However, conventional evaluation tools have difficulty accurately evaluating the output and detecting hallucinations when the output being evaluated is not worded the same as an expected output, contains additional true information, or is lacking information. For example, conventional evaluation tools may compare the expected output and the output. However, such comparison may falsely label the output as inaccurate if the expected output and the output are not similarly worded, even if the output is accurate. Thus, validating an accuracy of an output from an LLM remains a challenge.

Document conversion to convert documents into AI-ready formats for ingestion by LLMs or use by a RAG have historically depended on heuristic rules related to document formatting and document format specifications or OCR models with limited accuracy, which frequently fail to extract all the relevant information from documents including images, tables, and nonstandard text. These challenges limit the ability of document converters to accurately extract all the information from documents and hinder the integration of these documents with AI systems and RAG models as inaccurate conversions significantly decrease the accuracy of AI systems leveraging these documents.

### SUMMARY

Systems and methods are provided for converting documents with text and media such as images into machine-readable formats using an automated document conversion service and automated alternative text service. The converted documents may also be converted into an AI-ready format such that the converted documents can be ingested by LLMs or used by a RAG model. The converted documents advantageously retain media context in the converted documents (via alternative text and media reference) such that the converted documents can be used in an agentic RAG system for improved media searching using key words.

A large language model with an agentic RAG system according to at least one embodiment of the present disclosure comprises a retriever tool configured to search a converted documents database, the converted documents database having a plurality of converted documents, wherein each converted document includes text in a machine-readable format, a media reference, and alt text, wherein the media reference references extracted media data extracted from an original document during conversion of the original document to the converted document, and wherein the alt text is text that describes the extracted media data; and a media agent configured to, when prompted by the system with a query to search for target media data based on one or more key words, searches for the target media data by performing the operations of: directing the retriever tool to search the converted documents database for alt text that aligns with the one or more key words; receiving the media reference corresponding to the alt text that aligns with the one or more key words; searching a database for media data that matches the media reference; and outputting a path to the media data that matches the media reference.

Any of the aspects herein, wherein the converted documents database comprises a vector database having a plurality of vectors corresponding to a plurality of chunks, the plurality of chunks formed from dividing portions of similar content of the plurality of converted documents into a chunk of the plurality of chunks.

Any of the aspects herein, wherein the step of searching the converted documents database by the retriever tool includes searching within a target chunk of the plurality of chunks that has a vector embedding that matches a semantic content of the one or more keywords.

Any of the aspects herein, wherein the retriever tool also searches the converted documents database for the media reference.

Any of the aspects herein, wherein the alt text is generated by an automated alt text service comprising a vision language model configured to, when prompted with a prompt and media data, generates alt text for the media data, the alt text comprising text describing the media data.

Any of the aspects herein, further comprising: a user interface configured to receive the query to search for the target media data based on the one or more key words and to output a response to the query comprising the path to the media data.

Any of the aspects herein, wherein the media data comprises image data.

A method for searching for target media data using one or more key words according to at least one embodiment of the present disclosure comprises receiving, by a large language model with an agentic RAG system, a query to search for the target media data based on the one or more key words; prompting, by the large language model with the agentic RAG system, a media agent with the query and instructions to search for the target media data by performing the operations of: directing a retriever tool to search a converted documents database for alt text that aligns with the one or more key words, the converted documents database having a plurality of converted documents, wherein each converted document includes text in a machine readable format, a media reference, and alt text, wherein the media reference references extracted media data extracted from an original document during conversion of the original document to the converted document, and wherein the alt text is text that describes the extracted media data; receiving the media reference corresponding to the alt text that aligns with the one or more key words; searching a database for media data that matches the media reference; and outputting a path to the media data that matches the media reference; and outputting, by the large language model with the agentic RAG system, a response to the query, the response comprising the path to the media data.

Any of the aspects herein, wherein the converted documents database comprises a vector database having a plurality of vectors corresponding to a plurality of chunks, the plurality of chunks formed from dividing portions of similar content of the plurality of converted documents into a chunk of the plurality of chunks.

Any of the aspects herein, wherein the step of searching the converted documents database by the retriever tool includes searching within a target chunk of the plurality of chunks that has a vector embedding that matches a semantic content of the one or more keywords.

Any of the aspects herein, wherein the retriever tool also searches the converted documents database for the media reference.

Any of the aspects herein, wherein the alt text is generated by an automated alt text service comprising a vision language model configured to, when prompted with a prompt and media data, generates alt text for the media data, the alt text comprising text describing the media data.

Any of the aspects herein, wherein the media data comprises image data.

A document conversion system according to at least one embodiment of the present disclosure comprises an automated alternative (alt) text service comprising a vision language model configured to, when prompted with a prompt and media data, generates alt text for the media data, the alt text comprising text describing the media data; a document conversion service configured to convert a document from an input format to a machine-readable format by performing the operations of: inputting a document page of the document into a converter configured to convert text in the document page from the input format to the machine-readable format to yield a converted text page and to extract media data from the document to yield extracted media data; inputting the extracted media data into the automated alt text service to generate extracted alt text; receiving the extracted alt text; generating a media reference that comprises a path to the extracted media data; inputting the extracted alt text and the media reference into a location in the converted text page where the corresponding extracted media data was extracted; storing the converted text page with the extracted alt text and the media reference in a converted document.

Any of the aspects herein, wherein the document conversion service is further configured to convert the document from the input format to an AI-ready format.

Any of the aspects herein, wherein the converter comprises at least one of an optical character recognition (OCR) model or a document converter.

Any of the aspects herein, wherein the document conversion service is further configured to: provide the extracted alt text for review via a user interface; and receive a modified extracted alt text from a user interface after the step of receiving the extracted alt text.

Any of the aspects herein, wherein the document conversion system is an automated document conversion system.

Any of the aspects herein, wherein the document conversion system is an user interface-based automated document conversion system.

Any of the aspects herein, further comprising a content management system configured to manage conversion of the document to the converted document and revisions to the converted document.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a schematic illustration of a system that uses Network as a Service (Naas) according to at least one embodiment of the present disclosure;

FIG. 2 is a schematic diagram of a system for estimating a network quality according to at least one embodiment of the present disclosure;

FIG. 3 is an example graphical user interface according to at least one embodiment of the present disclosure;

FIG. 4 is a dataflow according to at least one embodiment of the present disclosure;

FIG. 5 is a logical topology according to at least one embodiment of the present disclosure;

FIG. 6A is a schematic diagram of training a scoring model according to at least one embodiment of the present disclosure;

FIG. 6B is a schematic diagram of a structure of the scoring model according to at least one embodiment of the present disclosure;

FIG. 7 is a flowchart according to at least one embodiment of the present disclosure;

FIG. 8 is a flowchart according to at least one embodiment of the present disclosure;

FIG. 9 is a schematic diagram of a validation system for a language model according to at least one embodiment of the present disclosure;

FIG. 10 is a detailed schematic diagram of a validation system for a language model according to at least one embodiment of the present disclosure;

FIG. 11 is a dataflow according to at least one embodiment of the present disclosure;

FIG. 12 is a table illustrating tests results of a scoring model according to at least one embodiment of the present disclosure;

FIG. 13 is a schematic diagram illustrating a dataflow for a document conversion service according to at least one embodiment of the present disclosure;

FIG. 14 is a schematic diagram illustrating a dataflow for an automated document conversion system according to at least one embodiment of the present disclosure;

FIG. 15 is a schematic diagram illustrating a dataflow for a user-interface based document conversion system according to at least one embodiment of the present disclosure;

FIG. 16 is a schematic diagram illustrating a dataflow for an LLM with an agentic RAG system according to at least one embodiment of the present disclosure;

FIG. 17 is a flowchart according to at least one embodiment of the present disclosure; and

FIG. 18 is a flowchart according to at least one embodiment of the present disclosure.

### DETAILED DESCRIPTION

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (i.e., X₁ and X₂) as well as a combination of elements selected from two or more classes (i.e., Y₁ and Zₒ).

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “agent” is a computer program that can perform tasks autonomously or semi-autonomously on behalf of a user or a system. In other words, the agent can operate independently of a human user or operator.

Furthermore, as used herein, the term “real-time” refers to at least one of the time of occurrence of the associated events, the time of measurement and collection of predetermined data, the time for a computing device (i.e., a processor) to process the data, and the time of a system response to the events and the environment. In the embodiments described herein, these activities and events occur substantially instantaneously.

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, i.e., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

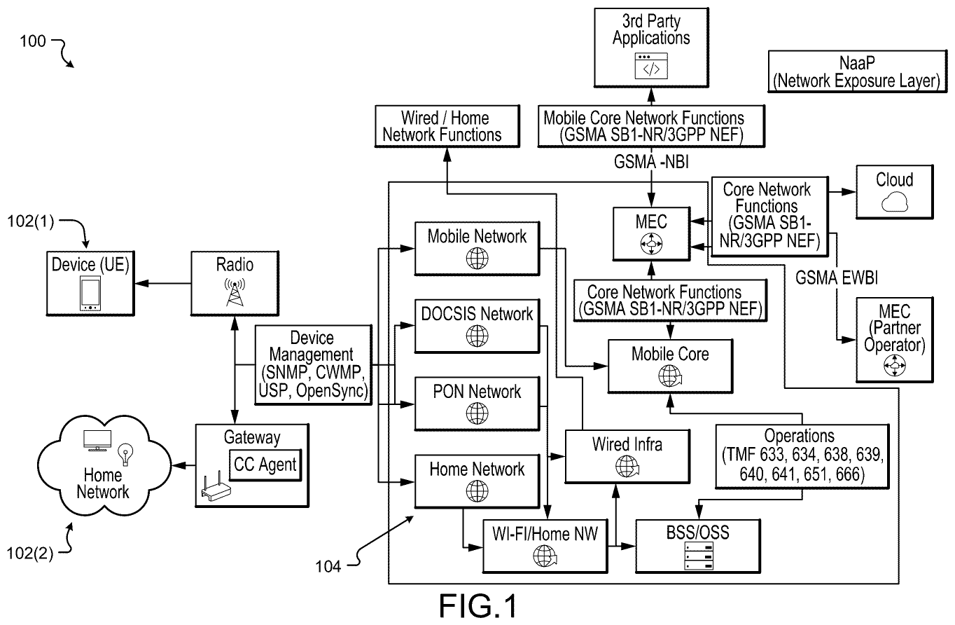

Turning to FIG. 1, a schematic illustration depicting a Network as a Service (NaaS) system (100) is provided for reference. As shown, multiple end users (102(1)), (102(2)) may access multiple networks (104) via the NaaS system (100). However, as previously described, a conventional NaaS system (100) cannot identify a location or root cause of an issue that occurs at an end user (102). For example, the root cause may be an issue at one of the networks (104); however, network data to determine such issue is not available to the end user (102). Similarly, the root cause may be an issue at the end user (102); however, end user data such as application key performance indicators (KPIs) are not available to the networks (104). Thus, it is desirable to monitor a quality of the end user's (102) network user to: determine when the end user's (102) use is impaired by quantifying the network quality using a scoring model, to identify a type and a location of the impairment, and to determine a resolution action for the impairment.

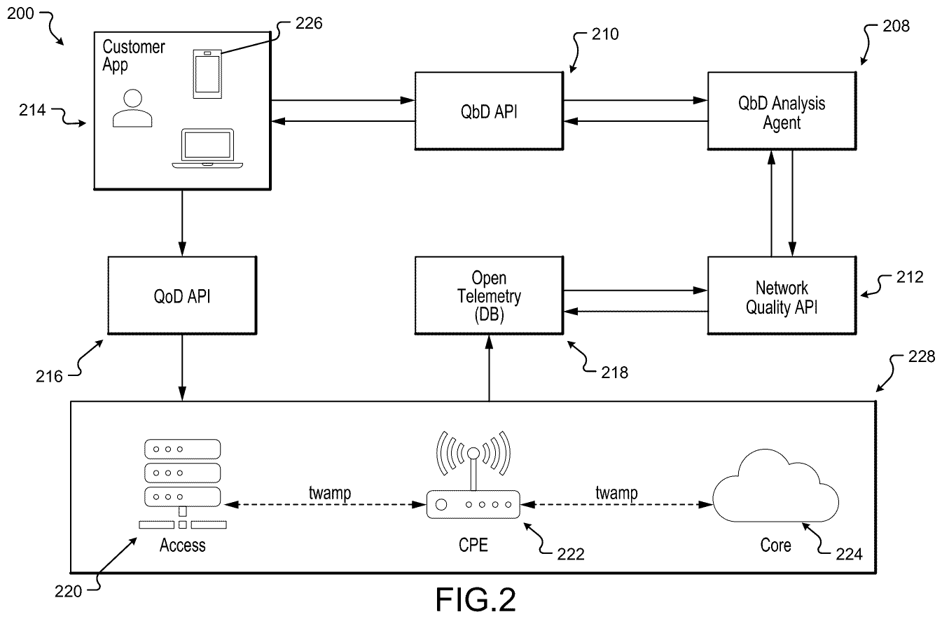

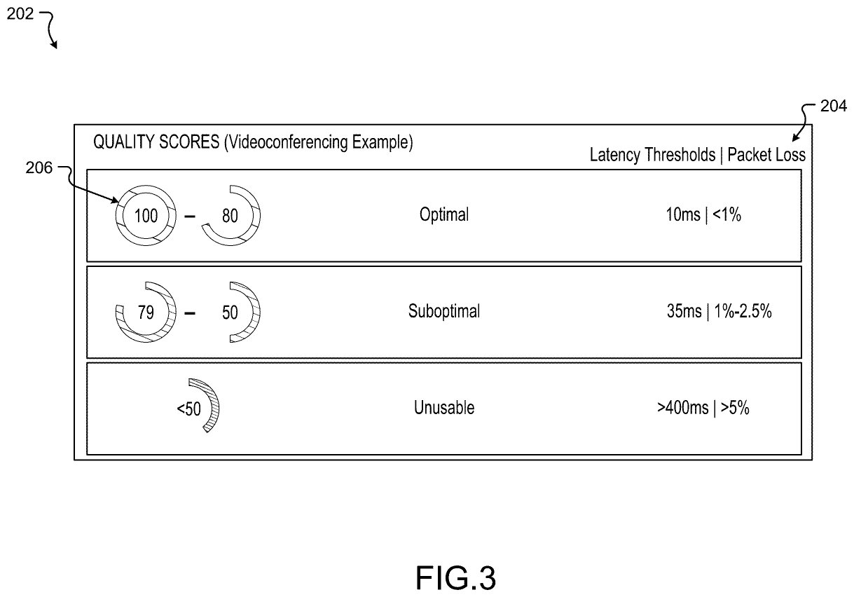

Turning to FIGS. 2 and 3, a schematic diagram of a system (200) for determining an impairment to an end user's network connection by quantifying the network quality and an example graphical user interface (GUI) (202) of predetermined thresholds (204) are respectively shown. The system (200) is used to monitor a quality of the end user's (102) use by determining an end user score (236) (labelled in FIGS. 3, 4, 5, 6A, and 6B) based on data received from the end users (102) and the networks (104) and determining a resolution action when the end user (102) experiences an impairment to their use.

As shown in FIG. 2, the system (200) includes an analysis agent (208) in communication with a first API (210) and a second API (212). The analysis agent (208) is an agent that can perform tasks related to receiving and analyzing application KPI(s) and network data. The analysis agent (208) can, for example, run a scoring model (234) using the application KPI(s), network data, and other measurements as input into the scoring model (234).

The first API (210) is also in communication with an end user application (214) and the second API (212) is also in communication with a data collector (218). The end user application (214) is also in communication with a third API (216), which may be in communication with an access network (220). The access network (220) is also in communication with a customer premises equipment (CPE) (222), which is in communication with a core network (224). The data collector (218) is also in communication with the CPE (222).

The first API (210) may be referred to as a gateway or quality by design API, the second API (212) may be referred to as a network quality API, and the third API (216) may be referred to as a quality on demand API. It will be appreciated that the first API (210), the second API (212), the third API (216), or any API may be, for example, a CAMARA based API.

The end user application (214) operates on a user device (226) such as, for example, a smart phone, a smart watch, a computing device, a laptop, or the like. The end user application (214) also operates over a network (228) via the NaaS system (100).

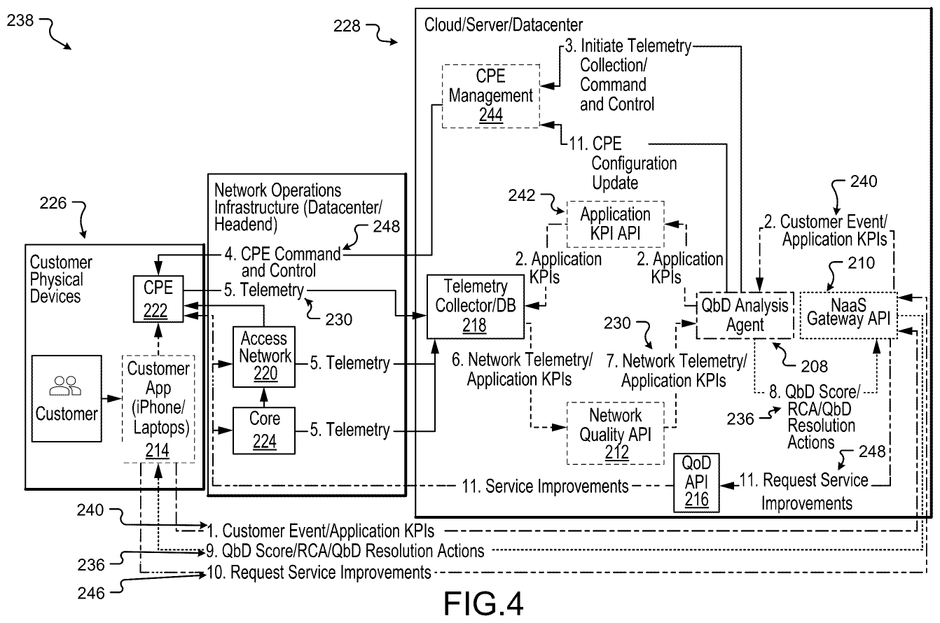

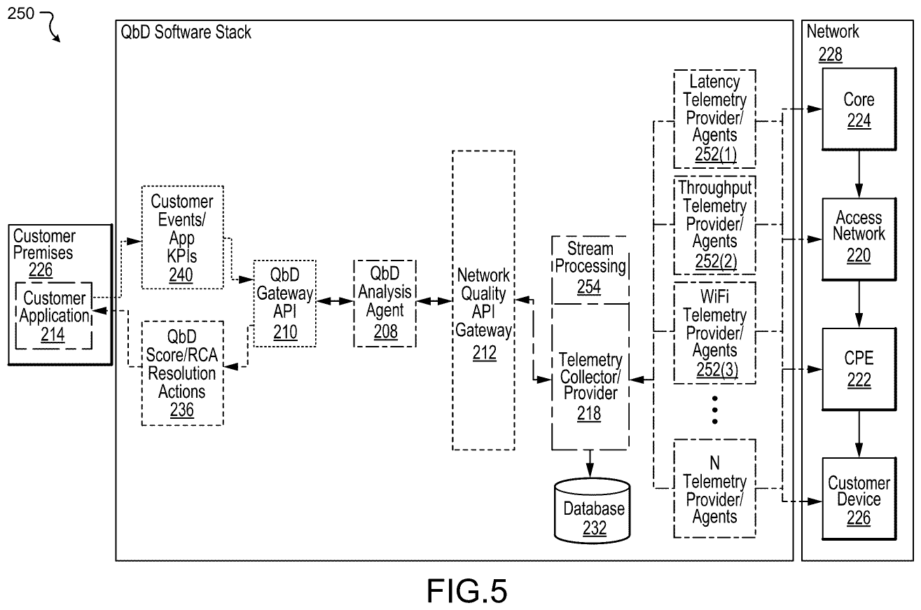

The CPE (222), the access network (220), and the core network (224) may be collectively part of the network (228). The CPE (222) may be, for example, a gateway and/or an access point and the core network (224) may be of a network operator (e.g., an MSO). Network data (230) (shown in FIG. 4) may be collected from the network (228) by the data collector (218). The data collector (218) may transmit such network data (230) to the analysis agent (208) in real-time. The data collector (218) may also store the data in a database (232) (shown in FIG. 5B).

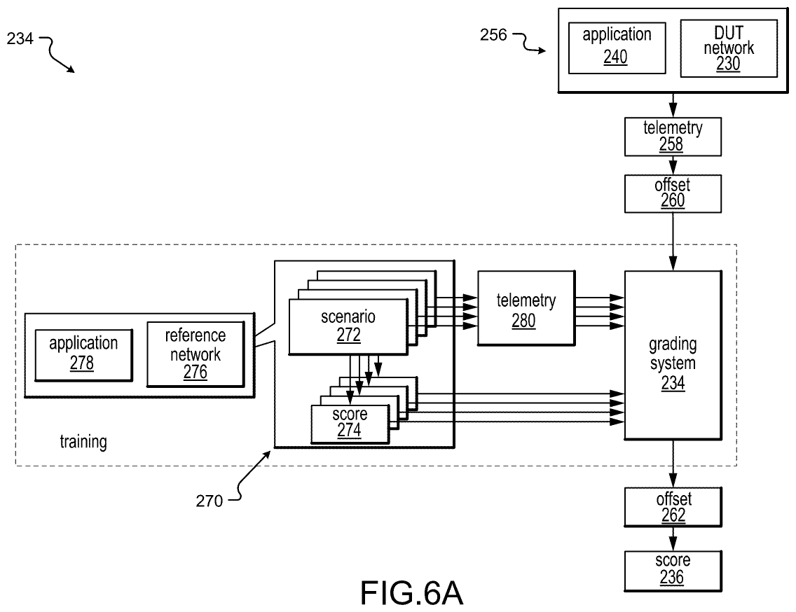

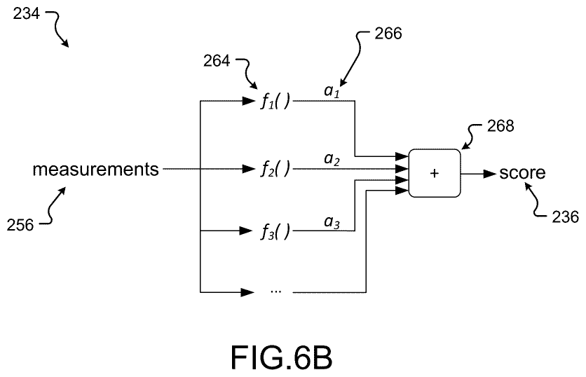

During use, the analysis agent (208) receives real-time measurements (256) (labelled in FIG. 6A) or measurements (256) from the database (232). The measurements (256) may be, for example, application KPIs (240) (labelled in FIG. 4) received from the end user application (214) via the first API (210). The network data (230) may be received from the data collector (218) (or the database (232)) via the second API (212). It will be appreciated that in some embodiments, the measurements (256) may be collected or measured in the cloud and stored in the database (232). The analysis agent (208) uses the measurements (256) as input into a scoring model (234) (shown in FIGS. 6A and 6B) to generate or output an end user score (236) that is compared to the at least one predetermined threshold (204) (shown in FIG. 3). Details of the scoring model are discussed in FIGS. 6, 7, AND 8.

As shown in FIG. 3, the at least one predetermined threshold (204) includes three ranges of predetermined thresholds displayed on an example GUI (202). In other embodiments, the at least one predetermined threshold (204) may include one predetermined threshold, two predetermined thresholds, or more than two predetermined thresholds. In the illustrated embodiment, the predetermined thresholds (204) and corresponding end user scores (236) include, for example:
Optimal=(Score) 100-80: (Threshold) latency 10 ms, packet loss<1%;
Suboptimal=(Score) 79-50: (Threshold) latency 35 ms, packet loss 1%-5%; and
Unusable=(Score)<50: (Threshold) latency>400 ms, packet loss>5%.

Turning to FIG. 4, a dataflow (238) of the system (200) is shown. The arrows in the topology and flow represent a direction of the communication, data, instructions, and/or telemetry. Additionally, the numbering may represent the order of the steps in the flow according to one embodiment. However, in other embodiments, the steps can occur in a different order. In some embodiments, some steps are in consecutive order (i.e., run in series) and other steps can occur at the same time (i.e., run in parallel). Some steps may also occur continuously while other steps may occur at a time interval or when requested. Lastly, the dataflow (238) may include more or less steps.

As shown, application KPIs (240) may be received by the first API (210) from the end user application (214). The application KPIs (240) may include one application KPI, two application KPIs, or more than two application KPIs. The application KPIs (240) may be, for example, bandwidth, framerate, packet latency, jitter, bit rate, and/or packet loss. The application KPIs (240) may be continuously received or received at a time interval (e.g., every 10 seconds, every minute, etc.) by the first API (210). It will be appreciated that the first API (210) can request, receive, and/or send the application KPIs (240), the end user scores (236), root cause analysis results, and/or resolution actions. After the first API (210) receives the application KPIs (240), the first API (210) transmits the application KPIs (240) to the analysis agent (208). The application KPIs (240) may also simultaneously or sequentially be sent to an application KPI API (242), which communicates with the database (232) to store the application KPIs (240) in the database (232).

The analysis agent (208) then requests or receives network data (230). The network data (230) may be data from the CPE (222), the access network (220), and/or the core network (224). More specifically, the network data (230) may be received from the CPE (222) via a CPE management (244), which is in communication with the CPE (222) and the analysis agent (208). In such instances, the analysis agent (208) may send a command (248) to the CPE (222) to receive network data. The CPE management (244) is also a control interface that can also increase the sending/receiving of the network data (230).

The CPE (222) is in communication with the database (232) and/or data collector (218) and may transmit network data (230) to the database (232) and/or the data collector (218). The network data (230) may also be received from the access network (220) and/or the core network (224) by the database (232) and/or the data collector (218). It will be appreciated that the network data (230) may be received and/or stored continuously, at a time interval, or by request. The third API (216) can also instruct the core network (224) and access network (220) to increase a speed of the network data (230) sent and/or increase the frequency and amount of network data (230) sent. The network data (230) may include, for example, KPIs such as packet latency, jitter, bit rate, packet loss, and/or other data.

The network data (230) is received by the analysis agent (208) from the database (232) and/or the data collector (218) via the second API (212). It will be appreciated that the second API (212) can request, receive, and/or send real-time network conditions, telemetry, and historical device measurements. As previously described, the analysis agent (208) uses the application KPIs (240) and the network data (230) (also referred to collectively as “measurements (256)”) to generate the end user score (236). The analysis agent (208) then compares the end user score (236) to the predetermined threshold (204) to determine whether the end user application (214) is experiencing an impairment.

If the end user application (214) is determined to be experiencing an impairment (e.g., the end user score is less than the predetermined threshold), then the analysis agent (208) can identify a type of impairment and/or a location of the impairment by conducting a root cause analysis. The root cause analysis may be conducted by, for example, process of elimination. In one example, the end user device's Wi-Fi connection may be checked by requesting network data and KPIs from the CPE (222), the access network (220) may be checked by requesting access network telemetry and KPIs, and the core network (224) may be checked by requesting core telemetry and KPIs. If the telemetry and KPIs for the Wi-Fi, CPE, access network, and core network are satisfactory, then the analysis agent (208) looks at the end user application (214) for the impairment. For example, is there Wi-Fi congestion on the end user's private network or is there upstream noise? If there is Wi-Fi congestion, then a resolution action to repair or improve the impairment can be identified such as prioritizing some applications and/or devices over other applications and/or devices. It will be appreciated that the root cause analysis can run through any number of scenarios to determine the impairment.

The analysis agent (208) can transmit the end user score (236), the root cause analysis, and/or the resolution action(s) to the end user application (214). In response, the end user application (214) can transmit a service improvement request (246) to the first API (210), which communications with the third API (216). The third API (216) can request, receive, and/or send actionable network optimizations, which may be automated or initiated by a user such as the end user, a developer, or a network operator. Further, the third API (216) can perform, for example, a speed boost, Wi-Fi Multimedia packet marking, low latency DOCSIS, and low latency and low loss (L4S), among other actions in response to the service improvement request (246).

The third API (216) executes service improvements (248) based on the type and location of resolution or repair needed. For example, if the impairment is on the end user's Wi-Fi, then the first API (210) sends instructions to the third API (216), which then requests service improvements on the CPE (222). If the impairments are on the core network (224) or the access network (220), then the third API (216) requests service improvements on the access network (220) or the core network (224), which may include notifying the network operator of the impairment and resolution action.

Turning to FIG. 5, a logical topology (250) of the system (200) is shown. The logical topology (250) illustrates an example flow of data from the end user device (226) to the analysis agent (208) and from the network (228) to the analysis agent (208).

As previously described, application KPIs (240) are received by the analysis agent (208) via the first API (210) and network data (230) is received by the analysis agent (208) via the second API (212). The network data (230) may be received from the data collector (218), which collects the network data (230) from the network (228) components such as, for example, the core network (224), the access network (220), the CPE (222), and/or the end user device (226). The network data (230) may be provided by one or more telemetry data agents (252) for each type of data collected. For example, latency data may be measured by a latency agent (252(1)), throughput data may be measured by a throughput agent (252(2)), Wi-Fi data may be measured by a Wi-Fi agent (252(3)), etc. The network data (230) may also be stored in the database (232). In embodiments where the network data (230) is collected in real-time, the network data (230) can be collected and processed by a stream processor (254) rather than stored in the database (232).

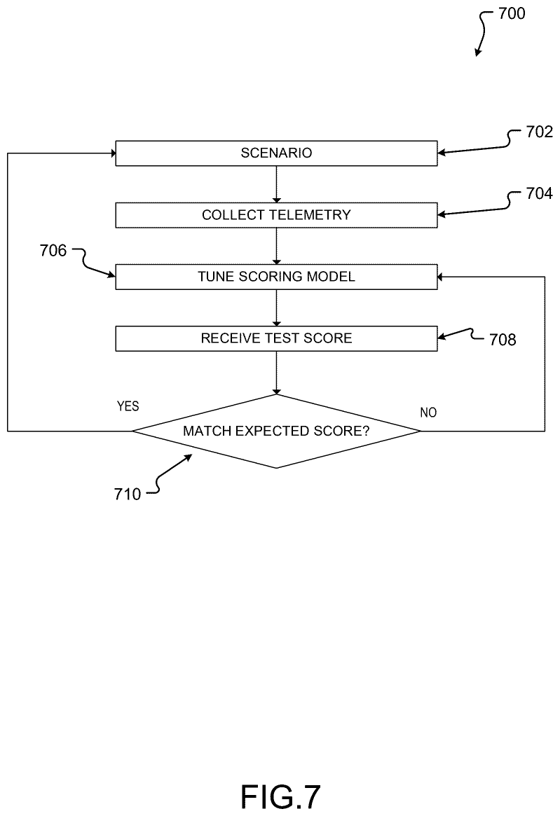

Turning to FIGS. 6A, 6B, and 7, a schematic diagram of training the scoring model (234), the scoring model (234), and a flow chart are respectively shown. As previously described, the scoring model (234) receives the measurements (256), which may be application KPIs (240) and network data (230), and outputs the end user score (236). The end user score (236) correlates to whether the end user application (214) is experiencing an impairment (e.g., the internet connection is unstable, low quality, and/or not functioning). The end user score (236) may be, for example, a scalar value that correlates to a grade that presents the health of current network operation. It will be appreciated that the scoring model (234) can be used in any application or use.

As shown in FIG. 6, measurements (256) such as application KPIs (240) and network data (230) from a network under testing may be transmitted via telemetry (258) to the scoring model (234). One or more offsets (260) may be applied to one or more measurements of the measurements (256) to, for example, match an effective region of the scoring model (234). In other words, the measurements (256) may be normalized before being inputted into the scoring model (234). The scoring model (234) then outputs the end user score (236) and an offset or adjustment (262) can be applied to the end user score (236) to match a scale (e.g., 1 to 100) and/or more accurately reflect a health of the network (228).

As shown in FIG. 7, the scoring model (234) specifically receives the measurements (256) and inputs the measurements (256) into one or more functions (264). Each function (264) outputs a value and the values from each function (264) are combined or summed at a summing function (268) to output the end user score (236). Each function (264) is also weighted by a weight (266), which can be set automatically or manually by a user such as, for example, a developer. The functions (264) may be, for example, mapping algorithms that are linear mapping, non-linear mapping (for example, polynomial mapping), machine learning, or kernal regression mapping. It will be appreciated that the functions (264) can be any type of function (264) and may include any number of functions (264) such as one function, two functions, or more than two functions. The weights (266) can be used to balance or weight the scoring model (234) between the different functions (264). For example, the weights (266) can be used to bias the scoring model (234) to be more linear, as will be illustrated in the example below.

In one specific example, each group of measurements (256) containing M-number of measurement values can be denoted as a vector x∈ [symbol] ^{M} and the output end user score y can be expressed as:

$$y = {\sum }_{i} {a}_{i} {f}_{i} ( x ) {\sum }_{i} {a}_{i} = 1$$

Where aᵢ are the weights (266) and ƒᵢ are the functions (264). It will be appreciated that ƒᵢ may include any number of functions such as one function, two functions, or more than three functions. In the illustrated example, ƒᵢ may have three functions where ƒᵢ is a linear mapping, ƒ₂ is a polynomial mapping, and ƒ₃ is a kernel regression mapping. In some instances, ƒᵢ may be a machine learning model. Thus, to weight the scoring model (234) as a linear model, aᵢ can be set as a₁=1 and a₂ and a₃=0. The weights (266) can also be used to balance or adjust the functions with respect to telemetry features and telemetry samples.

Returning to FIG. 6, the scoring model (234) is derived through training using training data (270). Such training data (270) may be labelled training data and can be used to train each function of the one or more functions (264). More specifically, the training data (270) can include scenarios (272) that are created from a physical reference network (276) and/or a simulation (278). The scenarios (272) can be used to produce test measurements (256) and resulting test end user scores (274) that are transmitted to the scoring model (234) via telemetry (280). For example, noise may be applied to a reference network to create a scenario (e.g., an impaired network connection) and an end user score may be given to the performance of the reference network under such scenario. Such measurements obtained from the scenario and the end user score given may then be used as training data.

The scoring model (234) can also alternatively be trained in an iterative process as shown in a method (700) of FIG. 7. As shown, the method (700) begins with a step (702) of executing a scenario, which produces measurements. The measurements are collected at a step (704) and inputted into the scoring model at a step (706). A test score is received at a step (708). The test score is compared to an expected score at a step (710). If the test score matches or matches the expected score within a predetermined range, then the method (700) repeats with a new scenario. If the test score does not match or does not match within a range with the expected score, then the scoring model and/or the measurements that are inputted into the scoring model are adjusted and a new test score is received. Such loop (e.g., adjusting the scoring model and/or the inputs) may be repeated until the test score matches the expected score or matches the expected score within a range.

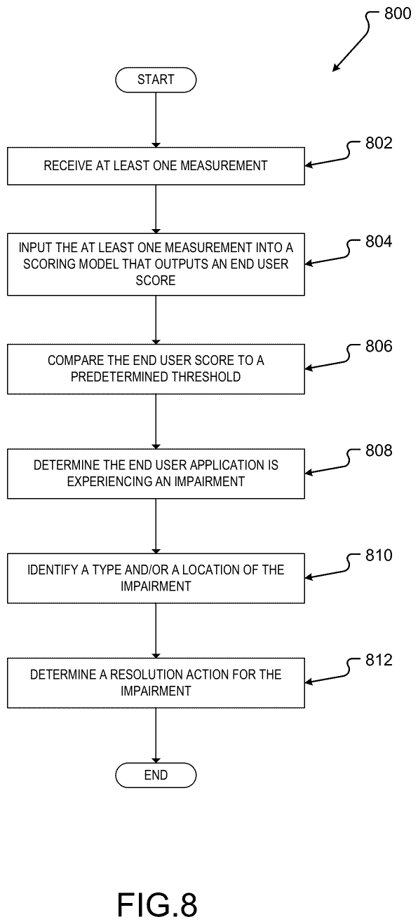

Turning to FIG. 8, a flowchart for a method 800 is provided. The method 800 may be used to determine whether an impairment is present in a network connection and to provide a resolution action for the impairment.

The method 800 includes receiving at least one measurement at step 802. The at least one measurement may be the same as or similar the measurements (256) and may be received by an analysis agent such as the analysis agent (208). As previously described, the measurements may include application KPIs such as the application KPIs (240) and network data such as the network data (230) obtained via telemetry. The application KPIs may be received from an end user application such as the end user application (214) via a first API such as the first API (210) and the network data may be received from a network such as the network (228) via a second API such as the second API (212).

The method 800 also includes inputting the at least one measurement into a scoring model that outputs an end user score at step 804. The analysis agent may input the measurement into the scoring model, which may be the same as or similar to the scoring model (234) and the end user score may be the same as or similar to the end user score (236). As previously described, the scoring model may receive the measurements and input each set of measurements into one or more functions. Each function outputs a value and the values are summed to generate the end user score. Each function is also weighted by a corresponding weight.

The method 800 also includes comparing the end user score to a predetermined threshold at step 806. The analysis agent may compare the end user score to the predetermined threshold, which may be the same as or similar to the predetermined threshold (204). The predetermined threshold may correlate to whether the end user application is experiencing an impairment such as, for example, an impairment to the end user's Wi-Fi connection.

The method (800) also includes determining that the end user application is experiencing an impairment at step (808). The end user application may be determined to be experiencing an impairment by the analysis agent when, for example, the end user score meets or is below the predetermined threshold. In other embodiments, the end user application may be determined to be experiencing an impairment when, for example, the end user score meets or is above the predetermined threshold.

The method (800) also includes identifying a type and/or a location of the impairment in step (810). Identifying the type and/or the location of the impairment may include conducting a root cause analysis by the analysis agent, as described in FIG. 4.

The method (800) also includes determining a resolution action for the impairment in step (812). The analysis agent may also determine the resolution action for the impairment based on the identified type and/or location of the impairment, as described in FIG. 4. The resolution action may also be transmitted to the end user application by the analysis agent, which may result in execution of the resolution action.

The method (800) may include more or less steps than described above. Further, any of the steps or any combination of steps may be repeated or continuously executed.

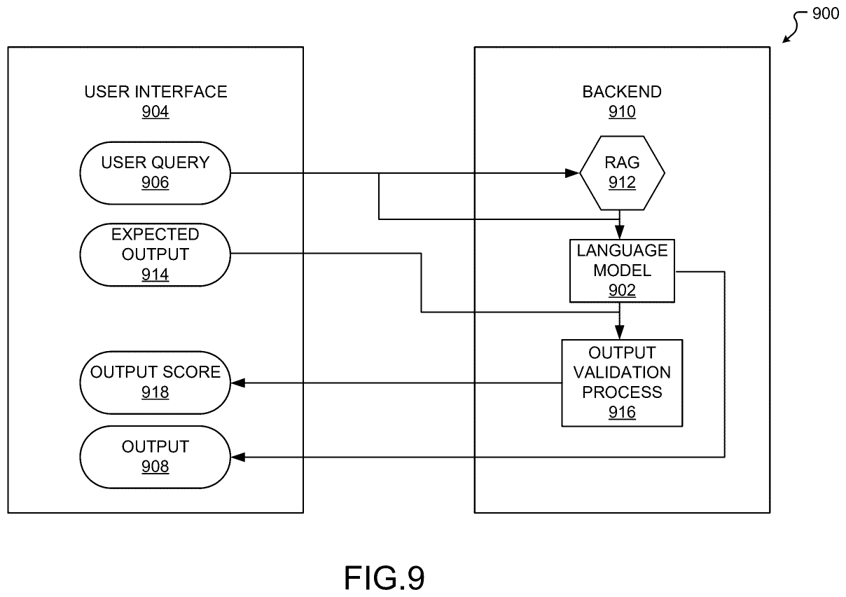

Turning to FIGS. 9-11, another embodiment of a scoring model and use of the scoring model in an example application will now be described.

FIG. 9 is a schematic diagram of a validation system (900) (“system (900)”) for a language model (902) according to at least one embodiment of the present disclosure. As shown, the validation system (900) includes a user interface (904) through which a user can submit a user query (906) to the language model (902). The user interface (904) may be, for example, a keyboard, mouse, trackball, monitor, television, screen, touchscreen, and/or any other device for receiving the user query (906) from the user and/or for providing an output (908) from the language model (902) to the user.

The user query (906) can include, for example, text, images, audio, or any combinations thereof and can be in the form of a prompt that instructs the language model (902) to generate the output (908). For example, the user query (906) can include a question for the language model (902) such as “What causes adjacency misalignment issues?”.

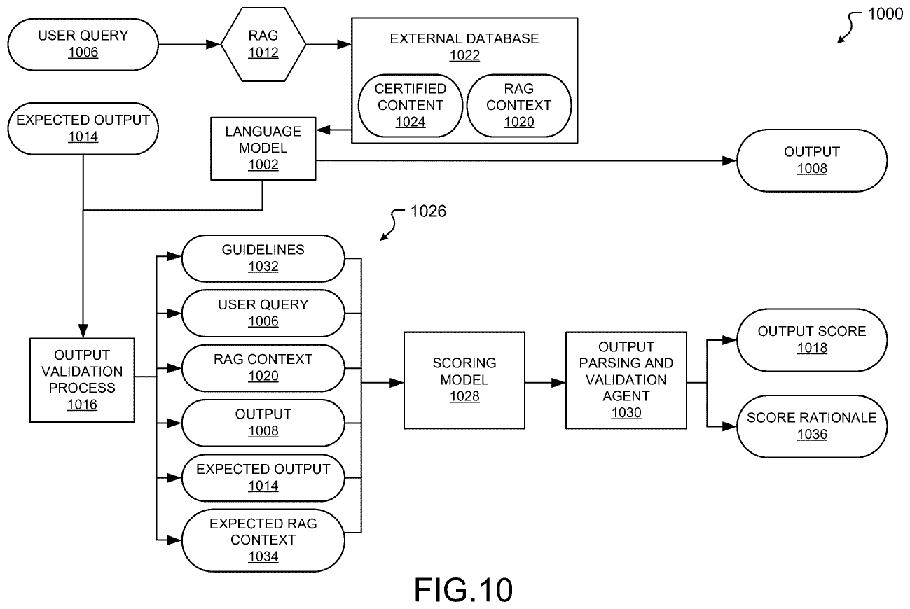

On a backend (910) of the system (900), the user query (906) is received by a Retrieval Augmented Generation (“RAG”) (912), which provides a RAG context (shown and described in detail in FIG. 10) to the language model (902). In some embodiments, the system (900) may not include the RAG (912) and the user query (906) may be received by the language model (902) without the RAG context.

The language model (902) receives the user query (906) and the RAG context and outputs an output (908) based on the user query (906) and the RAG context. The language model (902) is a natural language processing machine learning model. An example of the language model (902) may be a large language model (LLM), such as CHATGPT® or LLAMA®. However, many different language models may be used.

The output (908) can include, for example, text, images, audio, or any combinations thereof based on the instructions in the user query (906). For example, the output (908) can include an answer to the question in the user query (906) “What causes adjacency misalignment issues?”.

The output (908), an expected output (914), and one or more other inputs (e.g., the user query (906), the RAG context, etc.) are received as input by an output validation process (916), which will be described in detail in FIG. 10. The output validation process (916) includes a scoring model (shown and described in FIG. 10) that evaluates the output (908) based on one or more input information and outputs an output score (918), which correlates to an accuracy of the output (908) relative to an expected output (914) and other factors.

The output score (918) and the output (908) are then provided to the user via the user interface (904). The output score (918) may be provided as a percentage, a letter grade, or any other grading or scoring metric or label.

FIG. 10 is a detailed schematic diagram of a validation system (1000) (“system (1000)) for a language model (1002) according to at least one embodiment of the present disclosure. The system (1000) shown in FIG. 10 is a detailed example embodiment of the validation system (900) described in FIG. 9. It will be appreciated that the validation system (900), and more specifically, the output validation process (916) can be applied and used in any application such as, for example, any language models, LLMs, LLM/RAGs in which validation of an accuracy of an output is desired. The system (1000) described below is an example of one such application.

As shown, a user can submit a user query (1006) to a language model (1002). In the illustrated embodiment, the system (1000) includes a RAG (1012), which provides a RAG context (1020) with the user query (1006) to the language model (1002). In other embodiments, the system (1000) may not include the RAG (1012).

Generally, the RAG (1012) searches an external knowledge base (1022) that includes certified content (1024) that has been certified through a certification process. The RAG (1012) identifies certified content (1024) that is relevant to the user query (1006) and uses the identified certified content (1024) to generate the RAG context (1020) with the user query (1006) to the language model (1002). The RAG context (1020) can be in addition to context in the user query (1006) or can augment the context in the user query (1006).

Content that is provided to the external knowledge base (1022) can be in many different forms and is converted into vectors for storage in the external knowledge base (1022). It will be appreciated that in other embodiments, the content may be converted into any format for storage in the external knowledge base (1022). Prior to conversion, the content may be formatted based on one or more templates to ease ingestion and conversion of the content. The content may also be partially certified through the certification process (whether formatted to a template or unformatted) prior to conversion. In other words, the certification process can certify the content prior to conversion of the content into the vector format and/or after conversion of the content into the vector format.

The certification process ensures that certified content (1024) in the RAG (1012) is of high quality and properly curated for application and use cases of the RAG (1012) and the language model (1002). The certification process also increases the accuracy of outputs from the language model (1002) when the content is validated after conversion. The certification process may include, for example, adding additional content or alternative text to a content to aid the language model (1002) or providing peer review confirmation for specific use cases of the content and ensuring that the content after conversion is valid.

The certification process used is selected from one or more certification processes based on a type of the content such as, for example, whether the content is a standard and/or specification, a technical journal, etc. For example, content that is already peer-reviewed and from a source of high-standards may have a certification process with different levels than content that has not been peer-reviewed. Several example embodiments of certification processes for different types of context will now be described.

An example embodiment of a certification process for standards and/or specifications where the content has a well contained and specific purpose can include the following certification levels:

1. No additions to the content itself, which is by nature peer reviewed with high quality.

2. Alternative text from an expert (i.e., a person with deep knowledge in a field) and/or alternative text from an authoritative source (i.e., reputable and trustworthy references and/or entities in a field) may be added to the content.

3. An expert team and/or peer review may add questions and answers (Q/A) pairs of sufficient coverage of the content, confirmed and reviewed answers, and/or automated Q/A testing.

4. In addition to level 3, expert confirmation Q/A testing may be added to the content.

5. Peer review confirmation for specific use cases may be added to the content. Examples of such confirmation may include: does the use case's needs align with the purpose of the document and the Q/A testing that was conducted?

In another example embodiment, a certification process for content from technical conferences and/or technical journals in which content made be more general purpose can include the following certification levels:

1) No additions to the content itself, which may be lightly reviewed and not aligned to use cases as the content may be more general purpose.

2) No additions to the content itself if the content is aligned to use case categories.

3) The content may be peer reviewed for use case applications and ingestibility into the RAG (1012) and new context may be added to the content.

4) Expert provided alternative text may be added to the content. The alternative text can be provided either from the author of the content with peer review or an expert in the field.

5) Expert provided Q/A (either the author with peer review, or expert provided) for testing may be added to the content.

6) Automated review of the Q/A testing may be added to the content.

7) Expert review of the Q/A testing results may be added to the content.

8) Peer review confirmation for specific use cases may be added to the content. Examples of such confirmation may include: does the use case's needs align with the purpose of the document and the Q/A testing that was conducted?

In another example embodiment, a certification process of a RAG set or the RAG (1012) itself can include the following certification levels:

1) Content of the RAG (1012) is peer review content and/or content from a source authority.

2) The content are additionally peer reviewed.

3) Alternative text from experts and/or from a secondary source of experts are added to the content.

4) Q/As for the content are peer reviewed for testing.

5) The Q/As for the content are automatically tested.

6) The Q/A testing results are reviewed by expert(s) in the field; and

7) The content in the RAG (1012) are tested for specific use cases and sufficient results.

It will be appreciated that the certification processes described above are provided as example certification processes and the certification processes can include any number of levels and/or types of levels. Further, the certification process can include one certification process, two certification processes, or more than two certification processes.

Content being certified through the certification process may not go through all levels. For example, some content may go through two certification levels, while other content may go through all levels of the certification process. Such numbers of steps can be used to assign different certification levels based on the number of levels taken to certify the content. For example, content that is directly entered into the external knowledge base (1022) can be level 1 content and content that has gone through two steps of a certification process can be, for example, level 2 or level 1+ content. It will be appreciated that levels in any form (numerical, alphabetical, proportional, etc.) and any criteria can be used.

The certification level can be used, for example, by the language model (1002) or the RAG (1012) to weigh different certified content (1024). For example, certified content (1024) with higher certification levels may be weighted higher than certified content (1024) with lower certification levels and thus more deference may be given to the certified content (1024) with the higher certification level.

As previously described, the RAG (1012) provides the user query (1006) with the RAG context (1020) to the language model (1002), which generates an output (1008). As similarly described in FIG. 9, the output (1008) is validated using an output validation process (1016). The output validation process (1016) as shown includes a scoring model (1028) that scores the output (1008) based on one or more input information (1026). Output from the scoring model (1028) is then parsed or structured by an output parsing and validation agent (1030) into an output score (1038) and, optionally, a score rationale (1026).

The input information (1026) that is inputted into the scoring model (1028) includes, for example, one or more scoring guidelines (1032), the user query (1006), the RAG context (1020), the output (1008), an expected output (1014), and an expected RAG context (1034). The one or more scoring guidelines (1032) provides guidelines and instructions for the scoring model (1028) to score the output (1008) based on the input information (1026). For example, the scoring guidelines (1032) can include measuring an accuracy of the output (1008) relative to the RAG context (1020), measuring a relevancy of the output (1008) to the user query (1006), measuring an accuracy of the output (1008) relative to the user query (1006), measuring an accuracy of the RAG context (1020) to the expected RAG context (1034), and/or measuring a relevancy of the RAG context (1020) to the user query (1006). Such guidelines (1032) and set of input information (1026) enables the scoring model (1028) to more accurately evaluate the output (1008). For example, because the output (1008) is evaluated based on its relevancy to the user query (1006) and the RAG context (1020) in addition to the expected output (1014), inaccuracies due to wording that is not similar between the expected output (1014) and the output (1008) are reduced or eliminated.

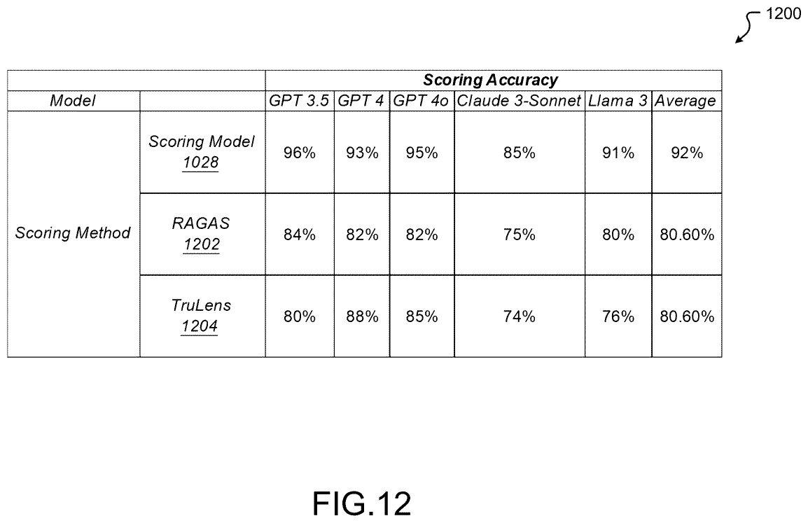

More specifically, the scoring model (1028) provided an improved scoring accuracy when tested and compared with other scoring tools such as, for example, RAGAS and TruLens. As shown in a table (1200) in FIG. 12, the scoring model (1028) had an average 11.4% increase in scoring accuracy compared to RAGAS (1202) and TruLens (1204) when tested on five test datasets. Thus, the enhanced accuracy provided by the scoring model (1028) provides an improved confidence in the system (1000) for evaluating and scoring outputs (1008) from the language model (1002).

As previously described, the output score (1018) may be provided as a percentage, a letter grade, or any other grading or scoring metric or label. The output score (1018) may also include more than one output score (1018) and can include two output scores (1018) or more than two output scores (1018). For example, the output score (1018) can include scores for an answer correctness, answer relevancy, context recall, faithfulness, answer similarity, and/or context relevancy. Similarly, the score rationale (1036) can include a corresponding number of score rationales (1036) for each output score (1018). The score rationale (1036) can include text that explains why the output (1008) was given the output score (1018). For example, if an output score (1018) is low (less than 50%), the score rationale (1036) may explain that the output (1008) does not align with the expected answer (1014) and may provide specific examples of the misalignment.

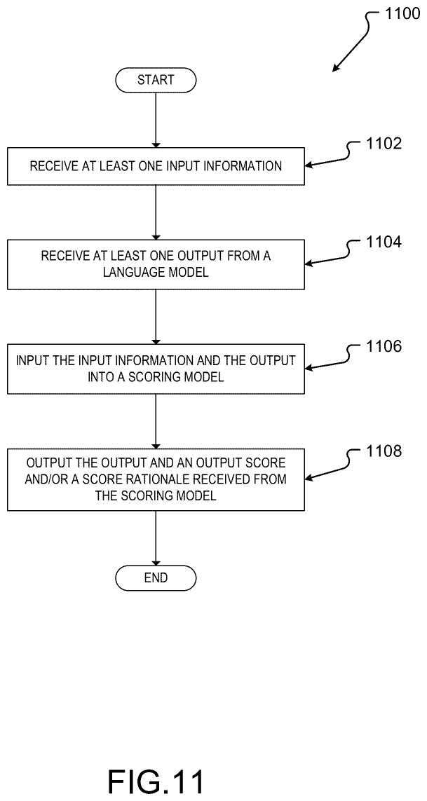

FIG. 11 is a dataflow of a method (1100) according to at least one embodiment of the present disclosure. The method (1100) can be used to validate and determine an accuracy of an output from a language model.

In step (1102) of the method (1100), at least one input information is received. The input information may be the same as or similar to the input information (1026) and may include, for example, one or more scoring guidelines such as the one or more scoring guidelines (1032), a user query such as the user query (906, 1006), RAG context such as the RAG context (1020), an expected output such as the expected output (1014), and an expected RAG context such as the expected RAG context (1034). The input information may be received from, for example, a language model such as the language model (902, 1002), a RAG such as the RAG (912, 1012), and/or a user interface such as the user interface (904).

Some of the input information may be stored in, for example, a database. For example, the guidelines, the expected RAG context and/or the expected outcome may be stored in a database and also retrieved from the database.

In step (1104) of the method (1100), at least one output such as the output (908, 1008) from the language model is received. The language model may be, for example, a large language model. Further, and as previously described, the language model can utilize the RAG, which is configured to search an external database and generate the RAG context for the user query. In such embodiments, the external database can include content that is certified through a certification process of one or more certification processes.

In step (1106) of the method (1100), the input information and the output are inputted into a scoring model such as the scoring model (1028). The scoring model may be, for example, a language model such as a large language model. In other embodiments, the scoring model may be any machine learning or artificial intelligence model. The scoring model uses the input information such as, for example, the guidelines to evaluate the output relative to the expected output, the user query, the RAG context, and/or the expected RAG context.

In step (1108) of the method (1100), the output and an output score such as the output score (1018) and/or a score rationale such as the score rationale (1036) received from the scoring model are outputted. As previously described, the output score may include more than one output score and the score rationale (if provided) may include a corresponding number of score rationales. The output, the output score, and the score rationale may be displayed in, for example, a graphical user interface (GUI) on a display of the user interface.

The method (1100) may include more or less steps. Further, the method or any step, steps, or combination of steps may be repeated. For example, the method (1100) may be repeated each time a user query is received.

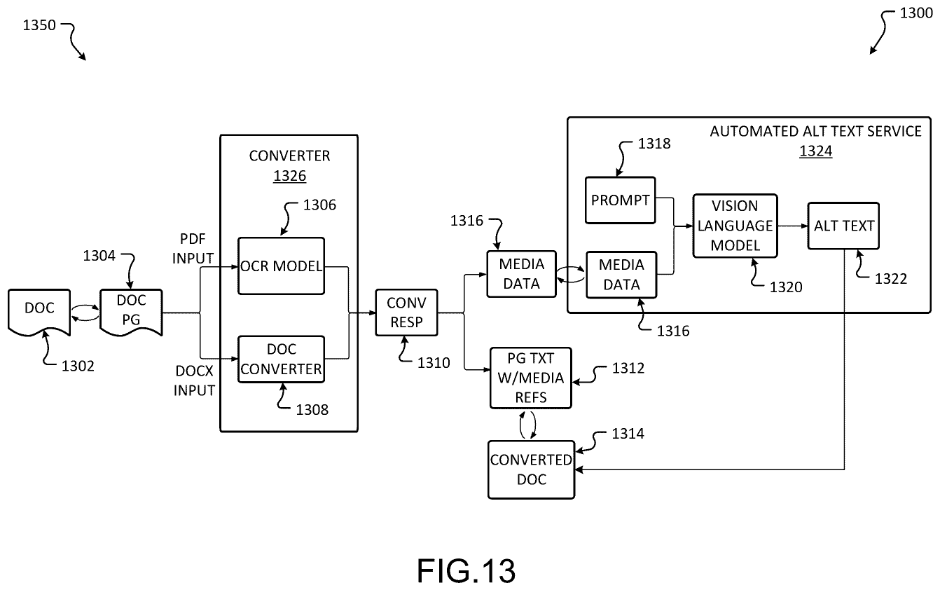

Turning to FIGS. 13, 14, and 15, a document conversion system that can automatically convert documents into a machine-readable format and/or an AI-ready format that is ingestible by a language model such as an LLM or for use by a RAG will be described. Generally the document conversion system uses a document conversion service to convert documents into machine-readable format and/or AI-ready formats for ingestion by AI models or use in a RAG model. For documents that include media data, the media data can be extracted, and an alternative (alt) text for the extracted media data may be automatically generated by a machine learning (ML)-based automatic alt text process. A media reference to a location of the stored extracted media data and the alt text may be inserted into the converted document, which retains media context and information in the converted document.

FIG. 13 is a dataflow (1300) for a document conversion service (1350). Generally, the document conversion service (1350) converts documents (1302) in an input format into a converted document (1302) in a machine-readable and/or AI-ready format. The dataflow (1300) may be executed using, for example, a processor or a computing device.

As shown in FIG. 13, the dataflow (1300) begins with a document (labelled as “doc”) (1302). The document (1302) is an electronic or a hard copy record that contains text, images, and/or multimedia. The document (1302) may be in any format such as, for example, a word processing format (i.e., a doc or docx file), a portable document format (i.e., a pdf file), a text format (i.e., a txt file), a POWERPOINT® presentation format (i.e., a ppt or pptx file), a spreadsheet format (i.e., an xls document), etc. The document (1302) includes one or more document pages (labelled as “doc pg”) (1304).

The dataflow (1300) includes determining the format of the document (1302) (e.g., docx, pdf, txt, ppt, xls, etc.) based on an extension on the document (1302) and inputting the document (1302) into a converter (1326) based on the determined format of the document (1302). As shown in FIG. 13, the converter (1326) can be an optical character recognition (OCR) model (1326) when the determined format is pdf or a document converter (1308) when the determined format is docx. It will be appreciated that in other embodiments, the converter (1326) can be a converter (1326) for any document format.

In embodiments where the converter (1326) is the document converter (1308), the document (1302) is received as input into the document converter (1308). More specifically, each document page (1304) of the document (1302) is extracted and received as input by the document converter (1308).

The document converter (1308) includes code that converts each document page (1304) from an input type such as the docx format into an output type such as a machine-readable format using deterministic methods. In some embodiments, the machine-readable format is an ASCIIDOC® format. In such embodiments, the resulting document page in the ASCIIDOC® format is a structured and machine-readable document page. The document converter (1308) may also be configured to extract media data embedded within a document page (1304) into separate files. The media data (1316) can include any media such as, for example, image data, audio data, video data, or animation data. The media data (1316) can be stored in, for example, a database.

The document converter (1308) outputs a conversion response (1310) that includes a converted page text and the extracted media data (1316). The converted page text can be in the machine-readable format such as the ASCIIDOC® format. Media references can be added to the converted page text at locations in the page text where the media data (1316) was extracted from to yield a converted page text with the media references (1312). The media references can provide a link or location path to the media data (1316) and also provide a place holder for alt text (1322) that describes the media data (1316). The process for generating alt text (1322) for the media data (1316) will be described further below in the ML-based automated alt text service (1324).

The converted page text with the media references (1312) and alt text (1322) can be added to the converted document (1314). The converted document (1314) is in a machine-readable format such as, for example, an ASCIIDOC® format or a Markdown format, and includes media references and alt text (1322) for the media data (1316) (if the document has media data). The converted document (1314) can be integrated into, for example, a RAG or ingestion by an LLM.

In embodiments where the converter (1326) is the OCR model (1306), the document (1302) is received as input into the OCR model (1306). More specifically, each document page (1304) of the document (1302) is extracted and received as input by the OCR model (1306).

Generally, the OCR model (1306) uses conventional OCR techniques and AI models to extract text and tables from documents (1302) and output the extracted text, image data, and tables in an output format such as a machine-readable format and/or an AI-ready format. The OCR model (1306) can be hosted locally or hosted externally. The OCR model (1306) is also configured to extract embedded media data. The extracted media data can be stored in, for example a database.

More specifically, a document page (1304) is received by the OCR model (1306), which uses code (when hosted locally) or makes an Application Programming Interface (API) call to an externally hosted OCR model to convert the document page (1304) into the output format (i.e., the machine-readable format) and to extract embedded media data in the document page (1304). The output of the OCR model (1306) is the conversion response (1310).

As previously described, the conversion response (1310) includes a converted page text with media references and the extracted media data (1316). The media references can provide a link to the media data (1316) and/or a place holder for alt text (1322) that describes the media data (1316). The process for generating alt text (1322) for the media data (1316) will now be described in the ML-based automated alt text service (1324).

The ML-based automated alt text service (1324) automatically generates alt text (1322) for the extracted media data (1316). The alt text (1322) is text that describes the media data (1316). The alt text (1322) can be used by, for example, accessibility products including screen readers.

The ML-based automated alt text service (1324) begins when a vision language model (VLM) (1320) is prompted with a prompt (1318) and the media data (1316) using code (when the VLM (1320) is hosted locally) or an API request to an externally hosted VLM (1320). The VLM (1320) is a multimodal AI model that can ingest and process text and media such as video and images. The VLM (1320) generates the alt text (1322) for the media data (1316) based on instructions provided in the prompt (1318).

The alt text (1322) can be stored in a database, and multiple alt texts (1322) can be stored separately in the database. By storing each alt text (1322) separately from each other, the alt text (1322) can be more easily tracked for each corresponding image or media file of the media data (1316). Further, storing each alt text (1322) separately from each other beneficially enables updating or editing a single alt text (1322) without interfering with other alt text (1322).

The alt text (1322) can be inserted into the converted page text with media references (1312) at the alt placeholders or the media references. Optionally, the alt text (1322) may be manually edited and/or approved prior to insertion into the converted page text with media references (1312). Each converted text page with media references and alt text can then be stored in the converted document (1314).

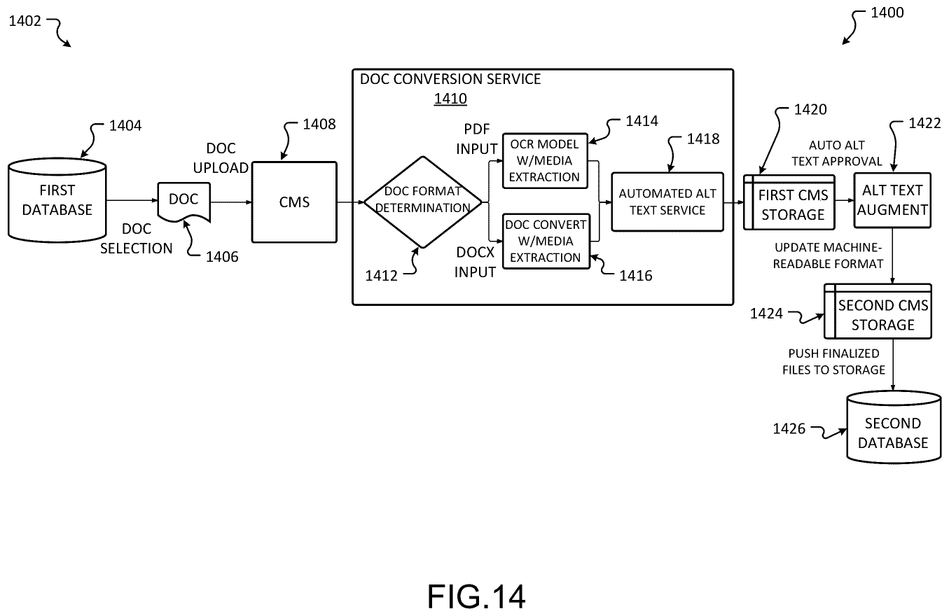

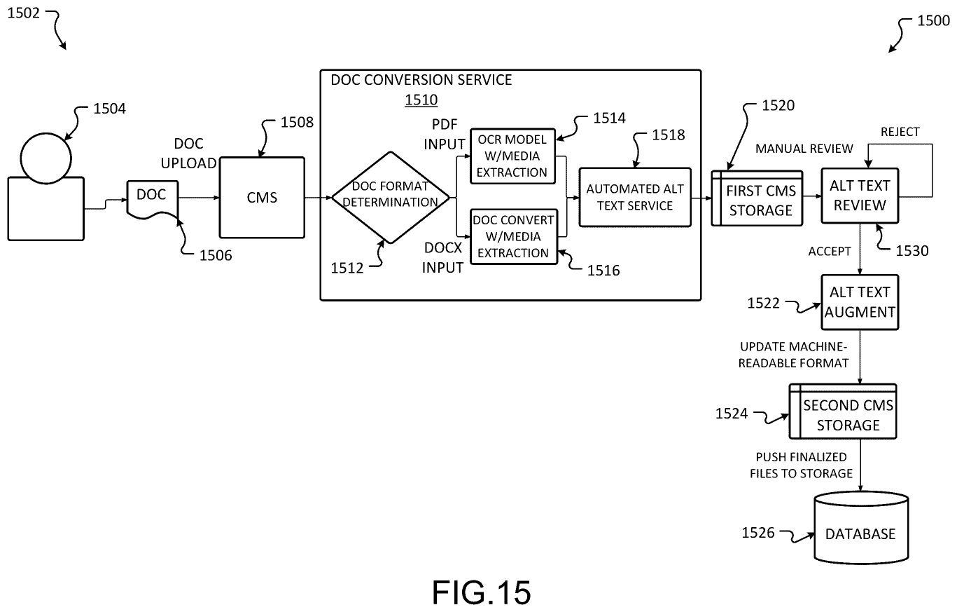

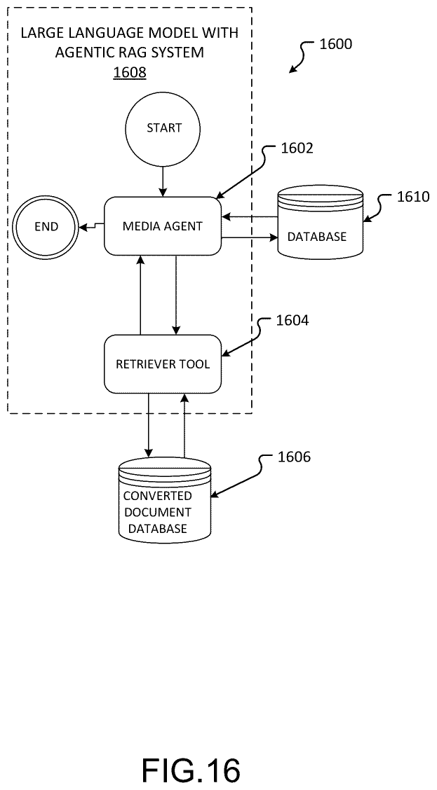

As previously described, the converted document (1314) with alt text (1322) is in an AI-ready format and can be ingested by AI or ML models or used by a RAG system. An example application of the converted document (1314) in an agentic RAG system for improved media searching will be described further below in FIG. 16. However, attention is brought to the document conversion system, which will now be described in FIGS. 14 and 15.

FIGS. 14 and 15 illustrate a first dataflow (1400) for an automated document conversion system (1402) and a second dataflow (1500) for a user interface (UI)-based document conversion system (1502), respectively. The dataflows (1400) and (1500) may be executed using, for example, a processor or a computing device.

Turning to FIG. 14, the automated document conversion system (1402) is shown. The automated document conversion system (1402) can run autonomously to convert documents using a document conversion service (1410) and API-based workflows. The document conversion service (1410) may be the same as the document conversion service (1350).

The automated document conversion system (1402) includes a first database (1404) that stores documents (1406), which may be the same as or similar to the documents (1304), for conversion. Documents (1406) may be manually submitted to the first database (1404) or may be automatically retrieved from external sources and submitted into the first database (1404).

The automated document conversion system (1402) also includes a content management system (CMS) (1408) for managing conversion of the documents (1406), storage of converted documents, managing revisions to converted documents, and storage of revised converted documents. The CMS (1408) is a headless CMS that receives user input via API endpoints. In other embodiments, the CMS (1408) may be a conventional CMS which uses a user interface to manage the documents.

The dataflow (1400) includes selecting a document (1406) from the first database (1404) for conversion by the document conversion service (1410). The document (1406) can be selected and uploaded to the document conversion service (1410) via the CMS (1408).

The document conversion service (1410) receives the document (1406) and determines a format of the document (1406) to yield a document format determination (1412). The document conversion service (1410) then routes the document (1406) to an OCR model with media extraction (1414) when the document (1406) is a pdf file or a document converter with media extraction (1416) when the document (1406) is a docx file. The OCR model with media extraction (1414) and the document converter with media extraction (1416) each output converted text with media reference and extracted media data.

The document conversion service (1410) then routes the extracted media data to an automated alt text service (1418) that is the same as or similar to the automated alt text service (1324). The automated alt text service (1418) prompts a VLM to generate alt text using the extracted media data and instructions from a custom prompt to generate the alt text.

The alt text can be temporarily stored in a first CMS storage (1420), then automatically approved by the automated document conversion system (1402). The alt text can then be augmented into a machine-readable format and/or an AI-ready format to yield an augmented alt text (1422). The augmented alt text (1422) can be temporarily stored in a second CMS storage (1424). The augmented alt text (1422) is then finalized and combined with the converted text pages or document and stored in a second database (1426) as a converted document.

Turning to FIG. 15, the UI-based document conversion system (1502) is shown. The UI-based document conversion system (1502) is similar to the automated document conversion system (1402) except that user input may be received at different points of the dataflow (1500). The UI-based document conversion system (1502) receives user input such as documents (1506) for conversion and instructions to convert the documents (1506) from a user (1504) via a UI.

The UI-based document conversion system (1502) also includes a content management system (CMS) (1508) for managing conversion of the documents (1506), storage of converted documents, managing revisions to converted documents, and storage of revised converted documents. The CMS (1508) is a conventional CMS which uses a user interface to manage the documents. Alternatively, in other embodiments, the CMS (1508) is a headless CMS that receives user input via API endpoints.

The dataflow (1500) includes receiving a document (1506) from the user (1504) (via a UI) for conversion by a document conversion service (1510). The document conversion service (1510) can be the same as or similar to the document conversion service (1350) of FIG. 13.

The document conversion service (1510) receives the document (1506) and determines a format of the document (1506) to yield a document format determination (1512). The document conversion service (1510) then routes the document (1506) to an OCR model with media extraction (1514) when the document (1506) is a pdf file or a document converter with media extraction (1516) when the document (1506) is a docx file. The OCR model with media extraction (1514) and the document converter with media extraction (1516) each output converted text with media reference and extracted media data.

The document conversion service (1510) then routes the extracted media data to an automated alt text service (1518) that is the same as or similar to the automated alt text service (1324). The automated alt text service (1518) prompts a VLM to generate alt text using the extracted media data and instructions from a custom prompt.

The alt text can be temporarily stored in a first CMS storage (1520), then manually reviewed in an alt text review (1530) by the user (1504) via the UI. If the alt text is rejected, then the user (1504) can adjust the alt text until approved. If the alt text is approved, then the alt text is augmented to a machine-readable format and the augmented alt text (1522) can be temporarily stored in a second CMS storage (1524). The augmented alt text is then finalized and combined with the converted text pages or document and stored in a database (1526) as a converted document. Extracted media data can also be stored in the database (1526).

Turning to FIG. 16, the example application of using a converted document such as the converted document (1314) of FIG. 13 by an agentic RAG system for improved media searching will now be described.

Conventional LLMs may have difficultly searching for images in a document using key words as different LLMs, even with a RAG system, searching the same document may describe the images using different terms and/or syntaxes. For example, a first model may describe images in the document using a first set of terms and a second model may describe the same images using a second set of terms that are different from the first set of terms. Thus, different models, or even the model run multiple times with the same query, may produce different images or may miss images based on a key word search for a given image.

Further, while comprehensive human-produced alt text mitigates the loss of information caused by the conversion of documents, the manual addition of alt text for all the images and embedded media content across hundreds or thousands of documents is incredibly time-consuming and tedious. Thus, the ML-based automated alt text service (1324) beneficially streamlines and greatly reduces time needed to convert documents with images to documents with alt text and image references.

FIG. 16 illustrates a dataflow (1600) of an LLM with an agentic RAG system (hereinafter “system”) (1608). The dataflow (1600) may be executed using, for example, a processor or a computing device.

The dataflow (1600) illustrates a process for searching for target media data based on key words using agentic RAG to retrieve alt text and/or media references from converted documents (which may be the same as or similar to the converted documents (1316)) stored in a converted documents database (1606) and using the alt text and/or media references to find the target media data in a database (1610).

Generally, the system (1608) determines which documents in a converted document database (1606) to search that are relevant to a search query for target media data based on key words. The converted documents in the converted document database (1606) are stored in a machine-language format and include media references and prior generated alt text for each media data that was extracted from a corresponding converted document. The prior generated alt text may have been generated automatically using, for example, the ML-based automated alt text service (1324) or other alt text process, or may have been manually generated by subject matter experts. The system (1608) then searches the converted document database (1606) for media references and/or alt text that align with the key words and retrieves, from a database (1610), one or more media data (or locations or paths thereof) corresponding to the media references and/or alt text. In other words, the media references and/or the alt text provide context to the system (1608) to locate the target media data in the database (1610). The system (1608) can then output the target media data in response to the search query.

More specifically, the system (1608) uses a media agent (1602) and a retriever tool (1602) to search the converted document database (1606). The media agent (1602) is a computer program that can perform tasks autonomously or semi-autonomously on behalf of the system (1608). The retriever tool (1602) is a computer program or application that performs tasks as directed by the media agent (1602). It will be appreciated that the system (1608) can include any number of media agents such as one media agent, two media agents, or more than two media agents. The system (1608) can also include any number of retriever tools such as one retriever tool, two retriever tools, or more than two retriever tools.

The converted document database (1606) includes converted documents that have been processed through a chunking and embedding process. In this process, the converted text for each converted document is split into smaller pieces of text that would fit within an LLM's context window using chunking. During chunking, the converted documents are split based on a heading format of each converted document, which preserves sections or subsections of similar content. By preserving sections or subsections of similar content from the original document, the chunking prevents the common failure case for chunking in which portions of similar content are divided among chunks and the full context for the topic is lost. Such preservation of topic context in the chunking strategy ensures that the LLM receives the full context of a topic from the document when using the chunks to answer user questions (such as searching for media data or image data using key words), further increasing the accuracy of the LLM responses.

Once all the converted documents in the converted document database (1606) have been split into chunks, each of the chunks are embedded using an embedding model. Embedding is a process of generating a numerical vector representation of the semantic content contained within each chunk. The vectors that result from embedding each of the chunks for all the converted documents in the converted document database (1606) are stored within a vector database; the vector database and the vectors that it stores are used to find the chunks of documents that are most similar to the user's query using a vector search.

The vector database is then integrated into a retrieval phase of a RAG pipeline using vector search, hybrid search, or other advanced retrieval strategies. These retrieval strategies involve embedding the user's query using the same embedding model that was used to embed the chunks from each of the documents in the corpus and determining the closest vector matches in the vector database. Frequently, the retrieval strategy includes a measure of the similarity between the semantic content in the user's query and the semantic content in each of the chunks in the vector database using the mathematical properties of both vectors. Once the closest matches are identified, the chunks of text corresponding to the closest vectors in the vector database are returned and added to the LLM's prompt. By adding these chunks of text to the LLM's prompt, the LLM has access to accurate information that is relevant to the user's question when generating its response to the user's query for, for example, image searching using key words, which makes its generated responses more accurate

The dataflow (1600) may begin by the system (1608) receiving a query to search for target media data based on one or more key words. The dataflow (1600) then prompts, by the system (1608), the media agent (1602) with a prompt that defines the media agent (1602) as an expert in determining which media data in the converted document database (1606) are most closely aligned with key words for a target media data. The media agent (1602) is also prompted to find media data from the converted document database (1606) that match or align with the key words.

The media agent (1602) then directs the retriever tool (1602) to search the converted document database (1606). More specifically, the retriever tool (1602) searches the vector database, described above, and searches for media references and/or alt text within the chunks whose vector embeddings match or align with the semantic context of the key words. The retriever tool (1602) then returns the relevant chunks and the system (1608) converts the media references in the relevant chunks into a list of media data numbers.

The media agent (1602) then searches a first set of data in the database (1610) for media data that matches each media data number and retrieves the path for each matched media data. The media agent (1602) also searches a second set of data in the database (1610) for a caption for each matched media data. The media agent (1602) then outputs the path and the caption for each matched media data. The system (1608) can then output a response to the query including the path and the caption for the matched media data.

An example of the dataflow (1600) will now be described. In the example, the system (1608) prompts the media agent (1602) with a prompt that defines the media agent (1602) as an expert in determining which images in a standard such as SCTE 294 or SCTE 280 are most closely aligned with the key words “images that show noise” or “images that show water waves or the frequency response from a water soaked drop cable”. The media agent (1602) then directs the retriever tool (1602) to search SCTE 294 or SCTE 280 for image references and alt text that align or match with “images that show noise” or “images that show water waves or the frequency response from a water soaked drop cable”. The retriever tool (1602) then returns a list of figure numbers corresponding to the matched image references. The media agent (1602) then searches the database (1610) for images that match each image number and captions for each image. The media agent (1602) then outputs a list of paths and captions for each image that corresponds to “images that show noise” or “images that show water waves or the frequency response from a water soaked drop cable”.

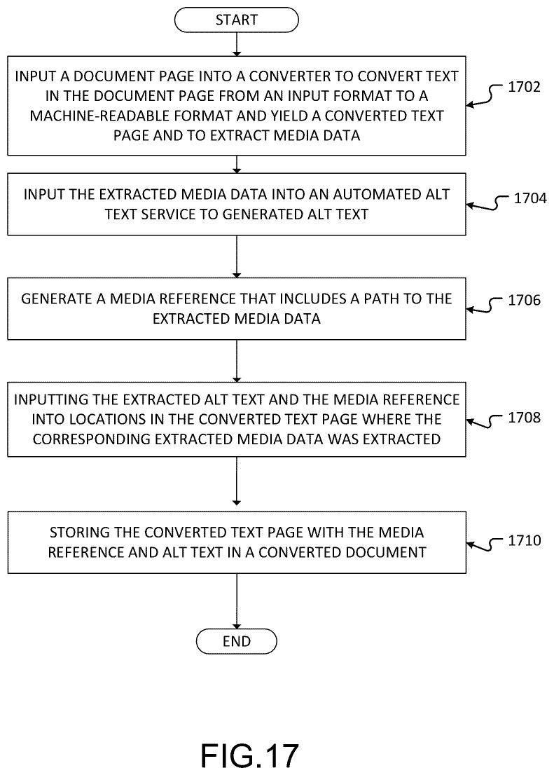

Turning to FIG. 17, a flowchart for a method of converting a document is provided. The method may be executed by any of the systems shown and described in FIGS. 13, 14, and 15. It will be appreciated that the steps 1702, 1704, 1706, 1708, and 1701 of the method shown below are described in detail via the dataflows of FIGS. 13, 14, and 15.

The step 1702 includes inputting a document page into a converter to convert text in the document page from an input format to a machine-readable format to yield a converted text page and to extract media data.

The step 1704 includes inputting the extracted media data into an automated alt text service to generate alt text for the extracted media data.

The step 1706 includes generating a media reference that includes a path to the extracted media data.

The step 1708 includes inputting the extracted alt text and the media reference into locations into the converted text page where the corresponding extracted media data was extracted.

The step 1710 includes storing the converted text page with the media reference and the alt text in a converted document.

The method of FIG. 17 can include more or less steps and the steps can be executed in any order.

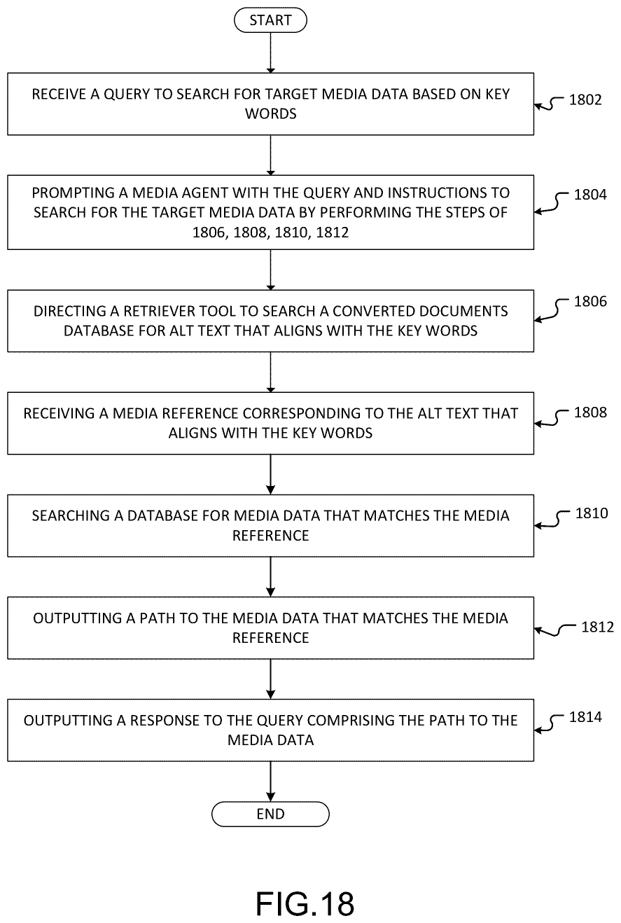

Turning to FIG. 18, a flowchart for a method of image searching is provided. The method may be executed by any of the systems shown and described in FIGS. 13, 14, 15, and 16. It will be appreciated that the steps 1802, 1804, 1806, 1808, 1810, 1812, 1814 of the method shown below are described in detail via the dataflows of FIGS. 13, 14, 15, and 16.

The step 1802 includes receiving, by an LLM with an agentic RAG system, a query to search for target media data based on one or more key words.

The step 1804 includes prompting, by the LLM with the agentic RAG system, a media agent with the query and instructions to search for the target media data by performing the operations of the steps 1806, 1808, 1810, and 1812 below.

The step 1806 includes directing a retriever tool to search a converted documents database for alt text that aligns with the one or more key words.

The step 1808 includes receiving the media reference corresponding to the alt text that aligns with the one or more key words.

The step 1810 includes searching a database for media data that matches the media reference.

The step 1812 includes outputting a path to the media data that matches the media reference.

The step 1814 includes outputting, by the LLM with the agentic RAG system, a response to the query, the response comprising the path to the media data.

The method of FIG. 18 can include more or less steps and the steps can be executed in any order.

Exemplary embodiments of systems and methods for document conversion and automated alt text generation for media and image data are described above in detail. The systems and methods beneficially provide a simplified and streamlined process for converting a large number of documents to an AI-ready document format. Such streamlined process results in a reduction in time needed to convert documents to an AI-ready format, thereby enabling faster integration of expert knowledge and organizational practices housed in the documents into AI systems.

The systems and methods also beneficially provide improved document conversion accuracy and reduced loss of information contained in figures, tables, and nonstandard formatting. The improved document conversion enables a streamlined deployment of multimodal RAG systems using the extracted multimedia formats, especially images, from all the documents in a database and robust linking between converted document text and multimedia content.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A large language model with an agentic RAG system, the system comprising:
a retriever tool configured to search a converted documents database, the converted documents database having a plurality of converted documents,
wherein each converted document includes text in a machine-readable format, a media reference, and alt text,
wherein the media reference references extracted media data extracted from an original document during conversion of the original document to the converted document, and
wherein the alt text is text that describes the extracted media data; and
a media agent configured to, when prompted by the system with a query to search for target media data based on one or more key words, searches for the target media data by performing the operations of:
directing the retriever tool to search the converted documents database for alt text that aligns with the one or more key words;
receiving the media reference corresponding to the alt text that aligns with the one or more key words;
searching a database for media data that matches the media reference; and
outputting a path to the media data that matches the media reference.

2. The system of claim 1, wherein the converted documents database comprises a vector database having a plurality of vectors corresponding to a plurality of chunks, the plurality of chunks formed from dividing portions of similar content of the plurality of converted documents into a chunk of the plurality of chunks.

3. The system of claim 2, wherein the step of searching the converted documents database by the retriever tool includes searching within a target chunk of the plurality of chunks that has a vector embedding that matches a semantic content of the one or more keywords.

4. The system of claim 1, wherein the retriever tool also searches the converted documents database for the media reference.

5. The system of claim 1, wherein the alt text is generated by an automated alt text service comprising a vision language model configured to, when prompted with a prompt and media data, generates alt text for the media data, the alt text comprising text describing the media data.

6. The system of claim 1, further comprising:
a user interface configured to receive the query to search for the target media data based on the one or more key words and to output a response to the query comprising the path to the media data.

7. The system of claim 1, wherein the media data comprises image data.

8. A method for searching for target media data using one or more key words, the method comprising:
receiving, by a large language model with an agentic RAG system, a query to search for the target media data based on the one or more key words;
prompting, by the large language model with the agentic RAG system, a media agent with the query and instructions to search for the target media data by performing the operations of:
directing a retriever tool to search a converted documents database for alt text that aligns with the one or more key words, the converted documents database having a plurality of converted documents, wherein each converted document includes text in a machine readable format, a media reference, and alt text, wherein the media reference references extracted media data extracted from an original document during conversion of the original document to the converted document, and wherein the alt text is text that describes the extracted media data;
receiving the media reference corresponding to the alt text that aligns with the one or more key words;
searching a database for media data that matches the media reference; and
outputting a path to the media data that matches the media reference; and
outputting, by the large language model with the agentic RAG system, a response to the query, the response comprising the path to the media data.

9. The method of claim 8, wherein the converted documents database comprises a vector database having a plurality of vectors corresponding to a plurality of chunks, the plurality of chunks formed from dividing portions of similar content of the plurality of converted documents into a chunk of the plurality of chunks.

10. The method of claim 9, wherein the step of searching the converted documents database by the retriever tool includes searching within a target chunk of the plurality of chunks that has a vector embedding that matches a semantic content of the one or more keywords.

11. The method of claim 8, wherein the retriever tool also searches the converted documents database for the media reference.

12. The method of claim 8, wherein the alt text is generated by an automated alt text service comprising a vision language model configured to, when prompted with a prompt and media data, generates alt text for the media data, the alt text comprising text describing the media data.

13. The method of claim 8, wherein the media data comprises image data.

14. A document conversion system comprising:
an automated alternative (alt) text service comprising a vision language model configured to, when prompted with a prompt and media data, generates alt text for the media data, the alt text comprising text describing the media data;
a document conversion service configured to convert a document from an input format to a machine-readable format by performing the operations of:
inputting a document page of the document into a converter configured to convert text in the document page from the input format to the machine-readable format to yield a converted text page and to extract media data from the document to yield extracted media data;
inputting the extracted media data into the automated alt text service to generate extracted alt text;
receiving the extracted alt text;
generating a media reference that comprises a path to the extracted media data;
inputting the extracted alt text and the media reference into a location in the converted text page where the corresponding extracted media data was extracted;
storing the converted text page with the extracted alt text and the media reference in a converted document.

15. The document conversion system of claim 14, wherein the document conversion service is further configured to convert the document from the input format to an AI-ready format.

16. The document conversion system of claim 14, wherein the converter comprises at least one of an optical character recognition (OCR) model or a document converter.

17. The document conversion system of claim 14, wherein the document conversion service is further configured to:
provide the extracted alt text for review via a user interface; and
receive a modified extracted alt text from a user interface after the step of receiving the extracted alt text.

18. The document conversion system of claim 14, wherein the document conversion system is an automated document conversion system.

19. The document conversion system of claim 14, wherein the document conversion system is an user interface-based automated document conversion system.

20. The document conversion system of claim 14, further comprising a content management system configured to manage conversion of the document to the converted document and revisions to the converted document.
